(19) United States
(12) Patent Application Publication
(10) Pub. No.: US 2014/0299343 A1
(43) Pub. Date: Oct. 9, 2014

(54) Disc and Coulter with Center Depression for Strength

(71) Applicant: Douglas G. Bruce, West Des Moines, IA (US)

(72) Inventor: Douglas G. Bruce, West Des Moines, IA (US)

(21) Appl. No.: 13/856,582

(22) Filed: Apr. 4, 2013

(51) Int. Cl. A01B 15/16; A01B 15/18; A01B 23/06

(52) U.S. Cl. CPC A01B 15/16; A01B 23/06; A01B 15/18
USPC 172/604

(57) ABSTRACT

An agricultural disc having a one piece metal plate is adapted to be rotated about a rotational axis. An inner circular section of the disc is disposed generally along a first plane. A outer section of the disc is disposed generally radially outwardly from the inner circular section, the outer section has an outer periphery which does not lie in the first plane. A transitional section of the one piece metal plate has an inner portion thereof connected to the inner circular section, the transitional section also having an outer circular portion thereof connected to an inner periphery of the outer section. The disc can be, but is not limited to, a flat or wavy coulter or a disc which can be concave/convex, with or without cut out portions.

### TECHNICAL FIELD

This invention relates generally to an agricultural disc or coulter and more particularly an agricultural disc or coulter with a center depression configured for strength.

### BACKGROUND

Disc shaped blades have been used to till the soil for at least over a century. These disc blades are sharpened on the outer periphery thereof. When they slice into the soil the abrasiveness of the soil eventually causes these blades to lose their sharpened edge. When the outer edge becomes dull, the discs cannot cut through plant trash on the surface of the soil and do not penetrate the soil as effectively as when they are new.

For discs made of the same material, the thicker the disc the stronger it is. At the same time, the thicker it is the more it costs and the problem of keeping the outer periphery sharp increases. Conversely, a thinner blade made of the same configuration and the same material is not as strong but the outer periphery remains sharper longer than for a comparable disc made of a thicker material.

U.S. Pat. No. 6,554,079 to Bruce (incorporated herein by reference) in FIG. 11 shows a gang of discs being used to till the soil. Some gangs of discs have notches in them and some do not, so it is important to note that these gangs of discs can be of many different configurations. These prior art discs are attached to a shaft which rotates with the discs themselves.

The greater the diameter of a disc the more of a lever arm force is applied where the disc is connected to the rotating shaft to which it is attached. For example in the prior art disc shown in FIG. 6, a lever arm has been labeled LA1 from the outer periphery of the disc D to the place where the disc D is attached to the shaft S. See the arrow labeled “Force” at the top of FIG. 6. If the distance LA1 is shorter there would be, of course, less breakage force applied at the shaft S. And if the distance LA1 is greater than that shown in FIG. 6, then, of course, there would be more breakage force applied at the point where the disc D is attached to the shaft S.

U.S. Pat. No. 6,378,622 to Kostrum shows a coulter construction with a central depression for receiving a bearing so that the coulter can rotate around the shaft upon which it is mounted. The coulter is attached with rivets to the bearing housing at a place radially out from the bearing housing depression. But the holes 6 with rivets 6′ through the coulter make it weaker and more likely to break at that point. In that case the lever arm would be from the outer periphery of the coulter 1 to the holes 6.

U.S. Pat. No. 2,291,722 to Ingersoll (incorporated herein by reference) shows the making of a disc with a flat central portion 19, but this flat central portion 19 lies in a plane which does not intersect the outer portions of the disc, so it has the same strength problems that an ordinary disc blade would have, namely that the lever arm would essentially the same as the lever arm LA1 in FIG. 6, so making the flat section 19 of no help in making the disc stronger.

Accordingly, if possible, there is a need for a way to make discs stronger so that a thinner disc of the same material will be as strong as thicker discs. Such a thinner disc will be will stay sharp longer and the material used to construct it will cost less.

### BRIEF DESCRIPTION OF THE DRAWINGS

The above needs are at least partially met through provision of the method and apparatus described in the following detailed description, particularly when studied in conjunction with the drawings, wherein:

FIG. 1 is a top view of a disc constructed in accordance with the present invention;

FIG. 2 is a cross sectional view taken along lines 2-2 of FIG. 1;

FIG. 3 is a perspective exploded view of two disc of a gang of discs like those shown in FIG. 4 on a square shaft with spacers between discs, the square shaft being adapted to be rotatably attached to an implement so that the discs are fixed to and rotatable with the square shaft;

FIG. 4 is a cross sectional view similar to the of FIG. 2 but of an embodiment of a disc with a completely planer central portion;

FIG. 5 is a cross sectional view similar to the of FIG. 2 but of an embodiment of a flat coulter with a completely planer central portion and a completely flat outer annular portion;

FIG. 5A is a cross sectional view similar to the of FIG. 2 but of an embodiment of a wavy coulter with a completely planer central portion; and

FIG. 6 is a cross sectional view similar to the of FIG. 2 but of a standard prior art disc of a type that has been used for decades.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

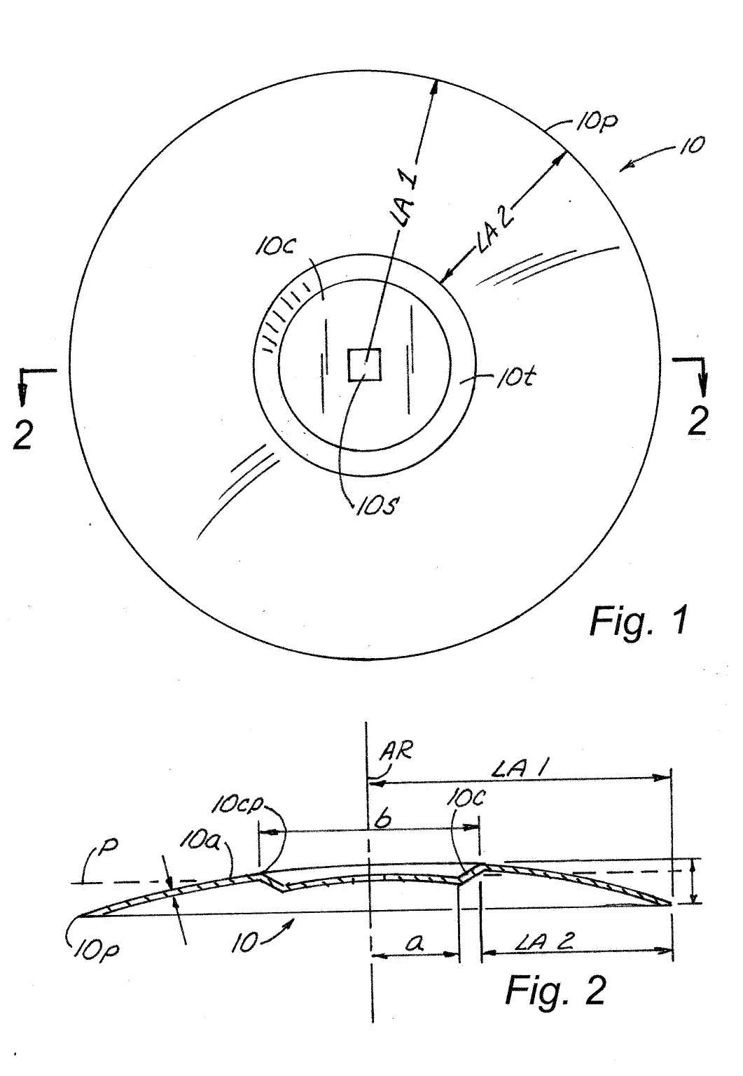

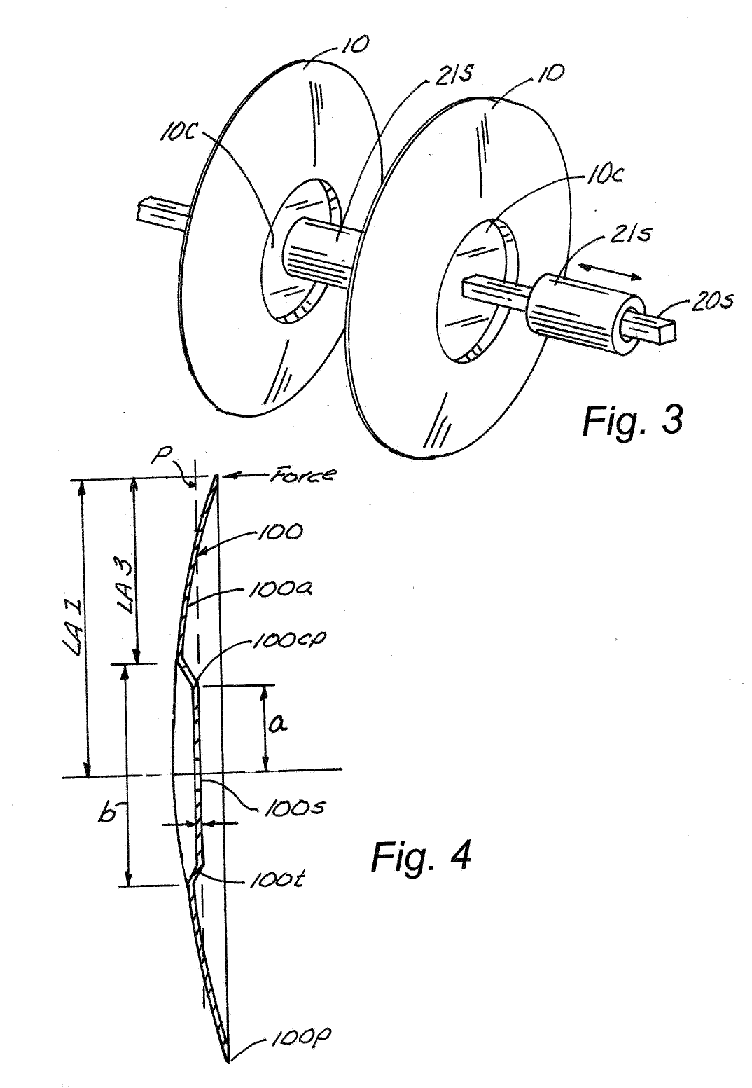

Referring now to the drawings, wherein like reference numerals indicate identical or similar parts throughout the several views, FIGS. 1 and 2 show a disc 10 constructed in accordance with the present invention. A central portion 10c has a central opening 10s for receiving a shaft 20s as shown in FIG. 3. FIG. 3 shows spacers 21s between adjacent discs 10.

The assembly shown in FIG. 3 could have many discs 10 with spacers 21s between them and the square shaft 20s would be rotatably attached to an implement similar to the gang of discs being used to till the soil shown in FIGS. 11 and 12 of U.S. Pat. No. 6,554,079. Of course the shaft 20s could be of any shape complementary to whatever the shape chosen for opening 10s in disc 10, or vise versa.

The disc 10 shown in FIGS. 1 and 2 has a central portion 10c which can be slightly curved but generally lies along a plane like central portion 100c of the disc 100 shown in FIG. 4. Discs 10/100 also have an annular outer portion 10a/100a and a transitional portion 10t/100t shown in FIGS. 2 and 4 respectively.

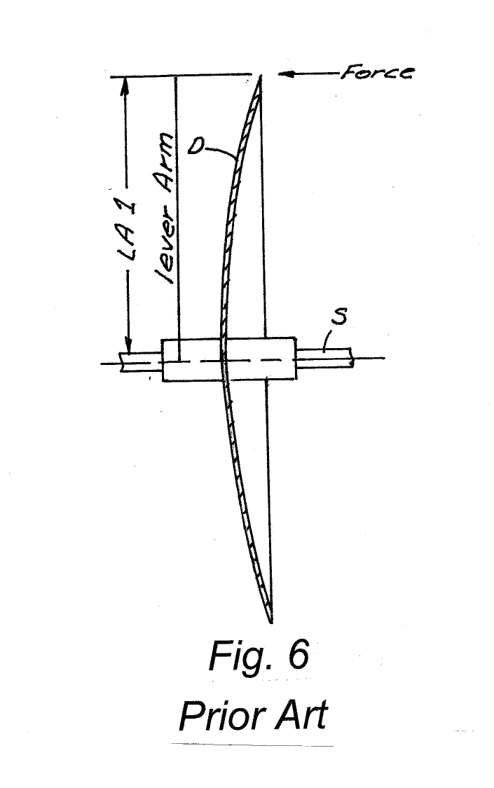

Looking again to FIGS. 1 and 2, there is a lever arm LA1 going from the rotational axis to the outer periphery 10p, like in FIG. 6, but the breaking force on the annular portion 10a is LA2, the distance from the outer part 10cp of transitional section 10t to the outer periphery 10p, not LA1, because of the existence of transitional portion 10t. The thickness of the disc 10 can be thinner, stronger and will stay sharp longer than comparable discs of a similar diameter that do not contain the transitional section 10t between the central portion 10c and the annular portion 10a.

Looking again at FIG. 2 it will be noted that the center section 10c lies generally along a plane P that extends through the curved annular portion 10a of the disc 10 as distinguished from U.S. Pat. No. 2,291,722 to Ingersoll which has a flat inner section 19 along a plane that does not intersect the outer curved portion the disc.

Similarly, looking to FIG. 4, there is a lever arm LA1 going from the rotational axis to the outer periphery 100p, like in FIG. 6, but the breaking force on the annular portion 100a is LA3, the distance from the outer part 100cp of transitional section 100t to the outer periphery 100p, not LA1, because of the existence of transitional portion 100t. The thickness of the disc 100 can be thinner, stronger and will stay sharp longer than comparable discs of a similar diameter that do not contain the transitional section 100t between the central portion 100c and the annular portion 100a.

Referring now again to FIG. 4 it will be noted that the center section 100c lies generally along a plane P that extends through the curved annular portion 100a of the disc 100 as distinguished from U.S. Pat. No. 2,291,722 to Ingersoll which has a flat inner section 19 along a plane that does not intersect the outer curved portion the disc.

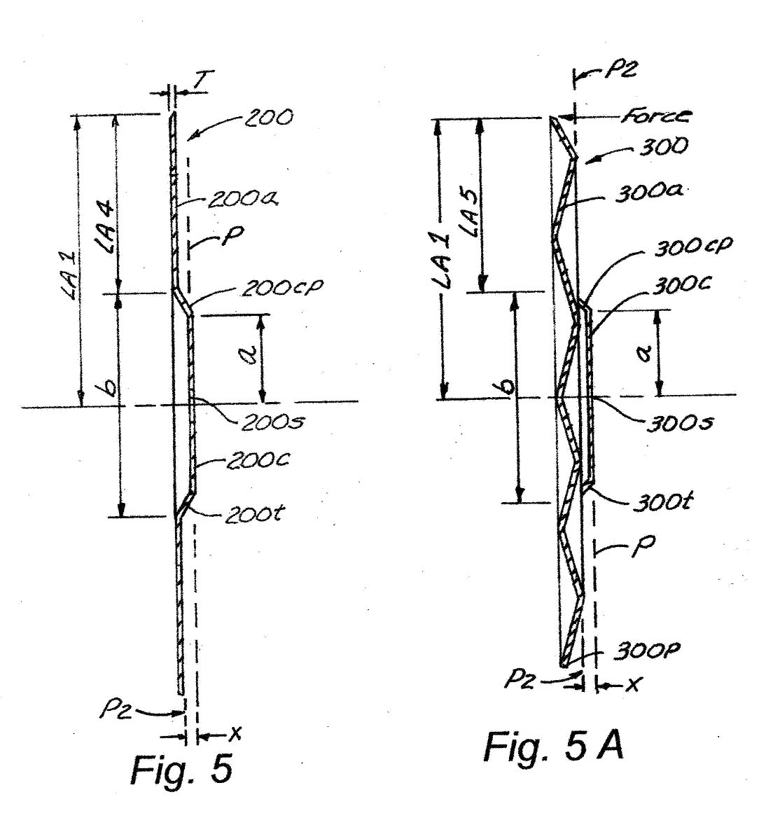

For the same reasons, looking to FIG. 5, there is a lever arm LA1 going from the rotational axis of coulter 200 to the outer periphery 200p, like in FIG. 6, but the breaking force on the flat annular portion 200a is LA3, the distance from the outer part 200cp of transitional section 200t to the outer periphery 200p, not LA1, because of the existence of transitional portion 200t.

In FIG. 5, the flat annular portion 200a lies generally in a first plane and the central portion 200c lies in a second plane spaced from the first plane by the width W of the transitional portion 200t. The thickness of the coulter T can be thinner, stronger and will stay sharp longer than comparable coulters of a similar diameter that do not contain the transitional section 200t between the central portion 200c and the annular portion 200a.

The rigid structural part of the first inner circular section 200c is adapted to be operatively affixed to a rotatable shaft 20s on an agricultural implement so as to rotate with the rotatable shaft 20s as distinguished from the coulter of U.S. Pat. No. 6,378,622 to Kostrum which uses a bearing 11 to rotate on the shaft 9, the connection 6/6′ on this Kostrum device being on the second outer section 1, outside of the transition section 2/5′, not on the inner circular section as in the present invention.

In FIG. 5, a second plane P2 is shown which generally defines the plane of outer annular part 200a and shows that it is spaced a distance X from the first plane P, generally defining the plane of the central section 200c.

For the same reasons, looking to FIG. 5A, there is a lever arm LA1 going from the rotational axis of wavy coulter 300 to the outer periphery 300p, like in FIG. 6, but the breaking force on the flat annular portion 300a is LA3, the distance from the outer part 200cp of transitional section 200t to the outer periphery 200p, not LA1, because of the existence of transitional portion 200t. This wavy coulter can be like that shown in U.S. Pat. Nos. 5,473,999 to Rawson et al. or 5,649,602 to Bruce, both of which are incorporated herein by reference in their entirety.

In FIG. 5A, the wavy annular portion 300a lies generally in and to each side of a second plane P2 and the central portion 300c lies in and on each side of a first plane P spaced from the first plane by the width X of the transitional portion 300t. The thickness of the wavy coulter can be thinner, stronger and will stay sharp longer than comparable coulters of a similar diameter that do not contain the transitional section 300t between the central portion 300c and the annular portion 300a.

The rigid structural part of the first inner circular section 300c is adapted to be operatively affixed to a rotatable shaft 20s on an agricultural implement so as to rotate with the rotatable shaft 20s as distinguished from the coulter of U.S. Pat. No. 6,378,622 to Kostrum which uses a bearing 11 to rotate on the shaft 9, the connection 6/6′ on this Kostrum device being on the second outer section 1, outside of the transition section 2/5′, not on the inner circular section as in the present invention.

In FIG. 5A, a second plane P2 is shown which generally defines the plane of outer annular part 300a and shows that it is spaced a distance X from the first plane P, generally defining the plane of the central section 300c.

In FIGS. 2, 4, 5 and 5A the distance “a” is the distance from the axis of rotation AR to the outer periphery of the transitional part 10t/100t/200t respectively. The distance “b” is the distance across or diameter of the outside of the transitional part 10t/100t/200t/300t.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept as expressed by the attached claims.

I claim:

1. An agricultural disc comprising:
a one piece metal plate adapted to be rotated about a rotational axis, the one piece metal plate having:
a first inner circular section disposed generally along a first plane, the first inner circular section having an outer circular periphery;
a rigid structural part of the first inner circular section being adapted to be operatively affixed to a rotatable shaft on an agricultural implement so as to rotate with the rotatable shaft;
an second outer section disposed generally radially outwardly from the inner circular section, the outer section having an outer periphery which does not lie in the first plane, the second outer section also having an inner periphery; and
a transitional section of the one piece metal plate which has an inner portion thereof connected to an outer circular portion of the first inner circular section, the transitional section having an outer circular portion thereof connected to the inner periphery of the second outer section.

2. The agricultural disc of claim 1 wherein the second outer section of the one piece metal disc lies generally in a second plane substantially parallel to the first plane in which the first inner section generally lies.

3. The agricultural disc of claim 2 wherein the agricultural disc is generally in the shape of a coulter.

4. The agricultural disc of claim 1 wherein the agricultural disc is generally in the shape of a wavy coulter.

5. The agricultural disc of claim 1 wherein the second outer section of the one piece metal disc comprises is an annular curved portion which is concave on one side and convex on the other side thereof, the first plane extending through the second outer section.

6. The agricultural disc of claim 1 further comprising a rotatable shaft operatively attached to the rigid structural part of the first inner circular section.

7. The apparatus of claim 6 further comprising at least two of the agricultural discs disposed on the rotatable shaft and a spacer disposed between them.
